(19) United States
(12) Patent Application Publication
(10) Pub. No.: US 2022/0304276 A1
(43) Pub. Date: Sep. 29, 2022

(54) VIRTUAL CONTAINMENT ZONE USING ULTRA-WIDEBAND

(71) Applicant: PupLinx, Inc., Short Hills, NJ (US)

(72) Inventors: Bradley FRANCO, Short Hills, NJ (US); Luis HERNANDEZ, Cordoba (AR)

(21) Appl. No.: 17/704,819

(22) Filed: Mar. 25, 2022

Related U.S. Application Data
(60) Provisional application No. 63/166,359, filed on Mar. 26, 2021.

(51) Int. Cl. A01K 11/00; G08B 21/18; H04B 1/7163; A01K 27/00

(52) U.S. Cl. CPC A01K 11/008; G08B 21/18; H04B 1/7163; A01K 27/009

(57) ABSTRACT

A virtual containment zone system is provided. The virtual containment zone system includes a plurality of beacons, a plurality of joining segments, and a tracking device. Each of the plurality of beacons employ ultra-wideband and define a vertex of a virtual containment zone boundary that forms the perimeter of a virtual containment zone. Each of the plurality of joining segments define the virtual containment zone boundary between two of the plurality of beacons. The tracking device comprises a processing device. The processing device is configured to determine the virtual containment zone boundary, enable one or more of the plurality of joining segments to take an action in response to a location of the tracking device, determine the location of the tracking device, determine, based on the location of the tracking device, an action to take, and send, to the tracking device, a signal to perform the action.

### CROSS-REFERENCE TO RELATED APPLICATIONS

The present application claims priority from U.S. Provisional Patent Application No. 63/166,359, titled Virtual Containment Zone Using Ultra-Wideband, filed Mar. 26, 2021 which is hereby incorporated by reference herein in its entirety.

### TECHNICAL FIELD

The present invention relates generally to a containment zone, and, more particularly, to a virtual containment zone using ultra-wideband.

### BACKGROUND

Location information pertaining to individuals, objects, and devices may be important in a variety of settings. For example, a company or organization may wish to track its employees and/or important assets. Location information may be pertinent for use with respect to any number of goals, including safety, security, efficiency, and the like.

One of the uses of location information is for tracking animals (e.g., pets, such as dogs). Most dogs, especially larger breeds, may require a lot of physical activity (e.g., jogging, playing fetch, etc.). As individuals gravitate to urban and suburban areas, it has become increasingly difficult to provide the necessary space for these larger pets to exercise.

Many suburban homeowners have turned to underground and/or wireless invisible fence containment systems. In general, most currently available pet containment systems work in much the same way. Such systems create a containment boundary (e.g., via an underground wire or determined wireless signal strength) and issue a corrective action if a pet gets close to or crosses the containment boundary. Generally, a device on a dog's collar is used to emit an audio and/or physical (e.g., vibration, electrical, etc.) stimulus as the corrective action. When combined with training, these stimuli are intended to condition the dog to remain within the containment area.

Underground containment systems have been in existence since the early 1970's and remain the most prevalent solution. Today, underground solutions come in a variety of packages, from professionally installed, including dog training, to do-it-yourself systems. Both underground and wireless systems have their advantages and disadvantages as discussed herein.

As discussed herein, current location tracking devices, e.g., pet containment zones, are generally limited to underground systems or wireless tracking systems. The majority of containment systems purchased today are professionally installed and can be prohibitively expensive. Not only is the upfront cost of an underground system high, but they have additional maintenance costs, for example, the underground wires can be easily broken by landscapers, roots, wildlife, etc. Additionally, underground systems and systems that require a large number of sensors are generally permanent and if you own a second home or business, or relocate to a new home or business, a new system installation would be required at the new/secondary location.

In addition to underground solutions, wireless systems are now available as well and are generally less expensive than professionally installed underground systems. However, such systems generally limit the containment or tracking zone to a circular shape of approximately three quarters (³/₄) of an acre or less, because they rely on Wi-Fi signal strength. Additionally, in the specific instance where the system is used for animal containment, it can be difficult to train a pet when the containment zone changes based on environmental conditions and/or signal interference, which may affect the signal strength and/or alter the boundary zone. Furthermore, both underground solutions and wireless solutions fail to take any proactive measures once the individual or object has breached the containment area or leaves the range of detection. Specifically, neither system has a method of tracking location information outside of the boundary of the containment zone.

Somewhat recently, solutions has become available on the market that incorporates a Global Positioning System (GPS) device. GPS systems may require professional installation in a roof or attic area of a structure to ensure that the system obtains the best possible GPS signal. As such, these systems are not easily relocated to additional or new locations. Moreover, the systems are highly inaccurate and thus require the owner to have a larger than average property (e.g., 3+acres) in order to operate the system optimally. However, even with the larger property, the inaccurate location information can make determining a location and boundary difficult.

Because of these limitations, a containment solution is needed that has the ease of use of wireless or GPS-based systems with the accuracy and trainability of the underground system.

### SUMMARY

In an exemplary embodiment a virtual containment zone system is provided.

The virtual containment zone system includes a plurality of beacons, a plurality of joining segments, and a tracking device having a processing device. Each of the plurality of beacons employ ultra-wideband and define a vertex of a virtual containment zone boundary that forms the perimeter of a virtual containment zone. Each of the plurality of joining segments define the virtual containment zone boundary between two of the plurality of beacons. The processing device is configured to determine the virtual containment zone boundary, enable one or more of the plurality of joining segments to take an action in response to a location of the tracking device, determine the location of the tracking device, determine, based on the location of the tracking device, an action to take, and send, to the tracking device, a signal to perform the action.

Various enhancements, refinements, and other modifications can be made to the aforementioned method in different embodiments. For example, in some embodiments, the tracking device is configured to function as a pet collar and the action to perform is to generate a corrective action to the tracking device. In some embodiments, the corrective action is comprises one or more of an electric shock, a vibration, and a played tone. In some embodiments, the tracking device includes a pet collar, a first unit, a second unit, and electrical components. The first unit may be attached to a first position on the pet collar and include a receiver and components configured to provide a corrective stimulus. The second unit may be attached to a second position on the pet collar and connected to the first unit by a conductive element. The first position and the second position may be separated on the pet collar by a distance. The electrical components may be configured to wirelessly communicate with the external processing device. The electrical components may be distributed between a first unit and a second unit such that a weight on the pet collar is distributed. In some embodiments, the second unit further includes a separate tracking system for tracking the tracking device outside of the virtual containment zone boundary, and the action to perform is to active the separate tracking system when the location of the tracking device is determined to be outside of the virtual containment zone. In some embodiments, the system further comprises an external processing device configured to wirelessly communicate with the tracking device and the tracking device is further configured to wirelessly communicate with the external processing device. In some of such embodiments, the method performed by the tracking device may further comprise transmitting, to the external processing device, the location of the tracking device. In some embodiments, the virtual containment zone includes a plurality of segment zones. Each segment zone may be an area within virtual containment zone. In some embodiments, the processing device may be further configured to receive, for each of the plurality of segment zones, corrective actions to perform in response to determining that location of the tracking device is within each of the plurality of segment zones and determining which of the plurality of segment zones comprises the location of the tracking device. In some embodiments, determining the action to take may be further based on the determined segment zone. A first corrective action for a first segment zone may be a higher severity than a second corrective action for a second segment zone.

According to another aspect of the invention a computer implemented method in a data processing system comprising a processor and a memory comprising instructions, which are executed by the processor to cause the processor to implement the method for tracking an asset in a virtual containment zone comprising a plurality of beacons. Each of the plurality of beacons may employ ultra-wideband. The method may include determining a boundary of a virtual containment zone, enabling each of the plurality of joining segments to take an action in response to a location of a tracking device, receiving a communication from each of two of the plurality of beacons, determining, based on the received communications, the location of the tracking device attached to an asset, determining an action to perform based on the location of the tracking device and the plurality of the enabled joining segments, and sending a signal to perform the action to the tracking device. The boundary may include a plurality of joining segments forming a continuous shape.

Various enhancements, refinements, and other modifications can be made to the aforementioned method in different embodiments. For example, in some embodiments, a joining segment exists between each of the plurality of beacons and the closest neighboring beacon for each of the plurality of beacons and determining the boundary of the virtual containment zone includes receiving a closest neighboring beacon for each of a plurality of beacons. In some embodiments, the method further includes receiving an instruction to disable one of the plurality of joining segments such that the tracking device can leave the virtual containment zone without receiving the action from an external processing device and disabling the one of the plurality of joining segments. In some embodiments, the action is to perform is to generate a corrective action to the tracking device. In some embodiments, wherein the action is to perform no action. In some embodiments, the action to perform is communicating with a smart device to activate the smart device. In some embodiments, the method further includes determining that the location of the tracking device is outside of the virtual containment zone and the action to perform is to active a GPS tracking feature of the tracking device. In some embodiments, the virtual containment zone includes a plurality of segment zones, wherein a segment zone may be an area within the virtual containment zone and, the method may further include receiving actions to perform in response to determining that location of the tracking device is within each of the plurality of segment zones for each of the plurality of segment zones, and determining which of the plurality of segment zones comprises the location of the tracking device. In some embodiments, determining the action to take is further based on the determined segment zone. In some embodiments, the method further includes determining a combined segment zone's boundary when a first segment zone of a first virtual containment zone overlaps with a second segment zone of a second virtual containment zone by determining that the first segment zone overlaps with the second segment zone, determining a first distance between the first segment zone and a first boundary of the first virtual containment zone, determining a second distance between the second segment zone and a second boundary of the second virtual containment zone, and determining the combined segment zone's boundary by prioritizing the first segment zone's boundary over the second segment zone's boundary. In some embodiments, the method further includes receiving a first communication from a first beacon and a second communication from a second beacon, determining a first distance from a tracking device to the first beacon based on the first communication, determining a second distance from a tracking device to the second beacon based on the second communication, determining a first potential location of the tracking device and a second potential location of the tracking device based on the first distance and the second distance, determining that the first potential location is within the virtual containment zone, and determining the location of the tracking device is the first potential location. In some embodiments, determining that the first potential location is within the virtual containment zone at a first time may be based on prior position of the tracking device at a previous time. In some embodiments, determining that the first potential location is within the virtual containment zone at a first time may be based on prior position of the tracking device at a subsequent time. In some embodiments, determining the location of the tracking device includes receiving a first communication from a first beacon, a second communication from a second beacon, and a third communication from a third beacon, determining, based on the first communication, a first distance from a tracking device to the first beacon, determining, based on the second communication, a second distance from a tracking device to the second beacon, determining, based on the third communication, a third distance from a tracking device to the third beacon, and determining, based on the first distance, the second distance, and the third distance, the location of the tracking device.

### BRIEF DESCRIPTION OF THE DRAWINGS

For illustrating some embodiments of the disclosure, there is shown in the drawings various embodiments, it being understood, however, that the disclosure is not limited to the specific instrumentalities disclosed as they are used for illustrative purposes only. Included in the drawings are the following Figures:

FIG. 1 depicts an illustrative system for enhanced location tracking for pet containment in accordance with an embodiment.

FIG. 2 depicts an illustrative example of an ultra-wideband beacon in accordance with an embodiment.

FIG. 3 depicts an illustrative exploded view of a beacon in accordance with an embodiment.

FIG. 4 depicts an illustrative example of a wireless remote tracking device in accordance with an embodiment.

FIG. 5 depicts an illustrative example of a virtual containment zone system in accordance with an embodiment.

FIG. 6 depicts an illustrative example of a virtual containment system in accordance with an embodiment.

FIG. 7A depicts an illustrative example of determining a location based on two beacons in accordance with an embodiment.

FIG. 7B depicts an illustrative example of determining a location based on two beacons and a known recent location in accordance with an embodiment.

FIG. 7C depicts an illustrative example of determining a location based on two beacons within an uncertainty zone in accordance with an embodiment.

FIG. 8A depicts an illustrative example of a series of zones defined around a segment formed between two beacons in accordance with an embodiment.

FIG. 8B depicts an illustrative example of the overlap in zones between multiple segments in accordance with an embodiment.

FIG. 8C depicts an illustrative example of the reconciliation of overlapping zones between multiple segments in accordance with an embodiment.

FIG. 9 depicts an illustrative example of trilateration based on three beacons in accordance with an embodiment.

FIG. 10 depicts an illustrative example of a data system in accordance with an embodiment.

### DETAILED DESCRIPTION

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present disclosure.

The present disclosure describes methods and systems for containment that do not require an underground wire or professional installation, are truly portable, and can be repurposed for multiple locations with minimal effort. Some of the embodiments described herein utilize one or more rechargeable devices (e.g., a rechargeable dog collar), three or more beacon transmitters, and a smart phone application to create and manage a containment zone (e.g., pet containment zone).

The containment device may be used to contain an asset. An asset, as used herein, may be anything a user wishes to contain within a virtual containment zone. For example, in some embodiments, the asset may be a pet. In another embodiment, the asset may be a piece of moveable equipment. In yet another embodiment, the asset may be a wallet.

The illustrated embodiments will be best understood by reference to the figures. The following description is intended only by way of example, and simply illustrates certain illustrative embodiments.

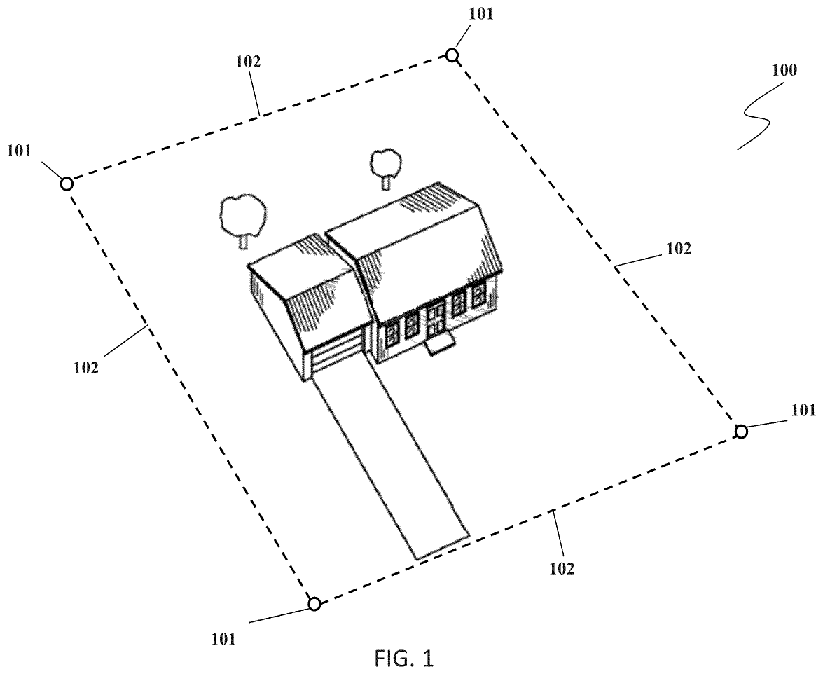

In reference to FIG. 1, a virtual containment zone system 100 is depicted in accordance with an embodiment. The virtual containment zone comprises a series of beacons 101 defining the vertices of a containment zone boundary, with the joining segments 102 between the beacons 101 defining the boundary itself. The beacons 101 may employ, for example and without limitation, ultra-wideband (UWB) technology. UWB is a wireless communication protocol for short-range communications. It utilizes radio waves and offers high bandwidth with low energy consumption. The virtual containment system 100 may further comprise one or more tracking devices (e.g., a pet collar) with integrated location-tracking and containment capabilities. In some embodiments, the beacons 101 and/or tracking devices may comprise components to wirelessly communicate (e.g., via WiFi or Bluetooth®) to an external processing device for configuring and receiving data from the virtual containment zone system 100. The external processing device may include dedicated hardware, a computer, or a mobile device, such as a phone or tablet. In further embodiments, the system 100 may be configured to connect via a local router to an external server, which may host communications between a user and the system 100 using an application or web-based solution.

In an embodiment, the initial configuration of the system 100 may be governed by a mobile application that assists a user with the design of the containment zone. The tracking device may have an integrated Bluetooth® chip with which it can receive signals from a Bluetooth-enabled smart phone for the initial set-up and configuration and future software updates. In some embodiments, the beacons 101 may not communicate with each other. Moreover, in some embodiments, the beacons 101 may not communicate with other devices outside the system 100 and/or may not be connected to a wireless communications network or to the Internet. Furthermore, the mobile application may permit monitoring of a pet or asset with respect to the boundary. The mobile application may be executed on a mobile information handling device, such as a smart phone, tablet, laptop, or the like. The mobile application may display a graphical user interface (GUI) related to the containment system 100 on a display device (such as a display device built into the mobile information handling device). As will be discussed further herein, the GUI may contain status information about the containment zone or the tracking device. In addition to status/monitoring information, the GUI may also allow one or more users to interact with the containment system 100 via one or more hardware and/or software devices (e.g., buttons, sliders, switches, etc.). In a further embodiment, the information displayed on the GUI regarding the containment system 100 may be transmitted via Wi-Fi, as discussed herein.

The present disclosure provides systems, methods, and/or computer program products for a containment system. The computer program product may include a computer-readable storage medium (or media) having computer-readable program instructions thereon for causing a processor to carry out various operations described herein.

The computer-readable storage medium is a non-transitory tangible device that can retain and store instructions for use by an instruction execution device (e.g., one or more processors). The computer-readable storage medium may be, for example and without limitation, an electronic, magnetic, optical, electromagnetic, semiconductor storage device, or any suitable combination of the foregoing. A non-exhaustive list of more specific examples of the computer-readable storage medium includes the following: a portable computer diskette, a head disk, random access memory (RAM), read-only memory (ROM), erasable programmable read-only memory (EPROM or Flash memory), static random access memory (SRAM), a compact disc read-only memory (CD-ROM), a digital versatile disk (DVD), a memory stick, a floppy disk, a mechanically encoded device, such as punch-card(s) or raised structures in a groove having instructions recorded thereon, and/or any suitable combination of the foregoing.

A computer-readable storage medium, as used herein, is not to be construed as one or more transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein may be downloaded to respective computing/processing devices from a computer-readable storage medium, or to an external computer, or external storage device via a network, for example, the Internet, a local area network (LAN), a wide area network (WAN) and/or a wireless network. The network may comprise conductive transmission cables (e.g., copper cables), optical transmission fibers, wireless transmission, routers, firewalls, switches, gateway computers, and/or edge servers. A network adapter card or network interface in each computing/processing device receives computer-readable program instructions from the network and forwards the computer-readable program instructions, for storage in a computer-readable storage medium, within the respective computing/processing device.

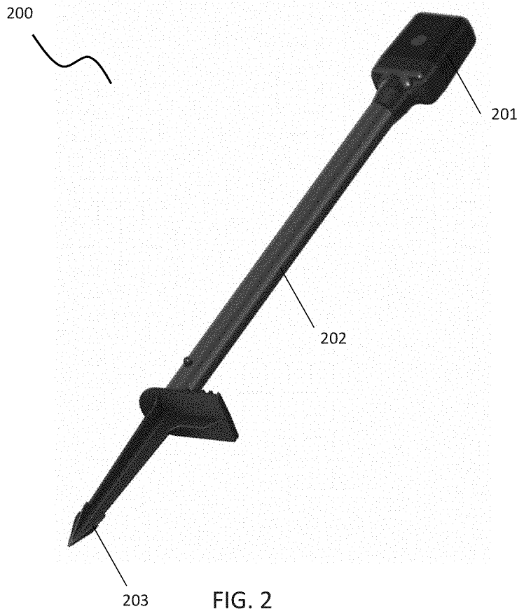

FIG. 2 provides an illustrative embodiment of a beacon assembly 200. The beacon 201 is mounted on a post 202 which improves the signal across the user's property by raising the device above ground level obstacles. The assembly 200 is kept in place by a stake 203 inserted into the ground.

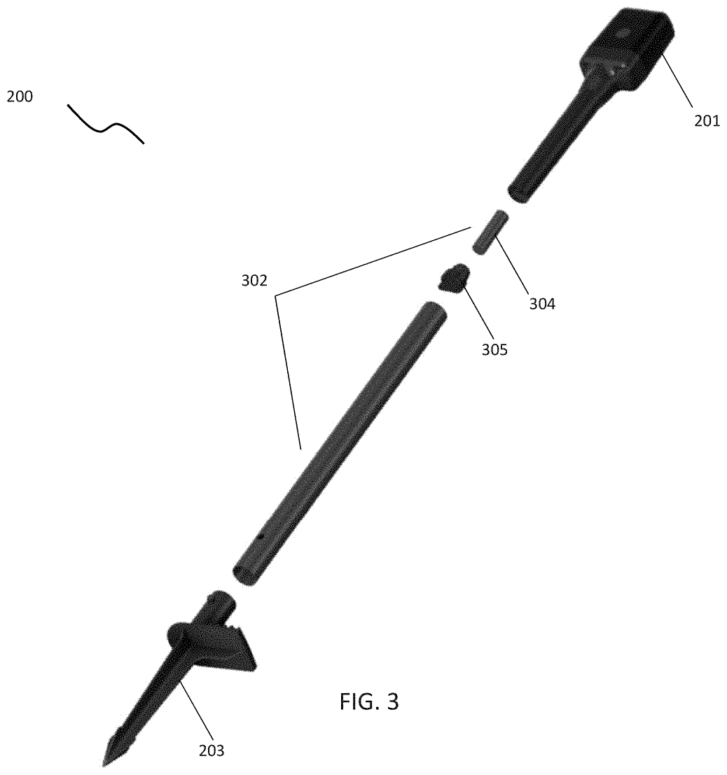

Referring to FIG. 3, the same assembly 200 is depicted in an exploded view. By removing the beacon 201 from the post 302, the internal batteries 304 may be replaced. In some embodiments the beacons may be configured to function at a specific height off the ground. In an alternative embodiment, multiple posts 302 may be joined via connectors 305 to achieve an optimal height to avoid signal obstruction across the containment zone.

In further embodiments, the beacons 201 may be of various sizes and shapes. It should be understood, that the shape and structure of the beacons 201 may be changed based on one or more design requirements. For example, some beacons 201 may be designed to be wall mounted, while others may be configured to mimic a bollard or pathway light. In a further embodiment, the beacons may be designed to look like vegetation or shrubbery. In some embodiments, national or local ordinances and/or regulations may only allow installations of a certain type. For example, fixed installation UWB transmitters are more heavily regulated by the FCC.

In some embodiments, the UWB transmission may operate at a frequency range of about 3.1 GHz to about 10.6 GHz. The transmission power of the beacon 201 may be about −41.3 dBm, which complies with the maximum EIRP levels established in the FCC's rules for several UWB applications.

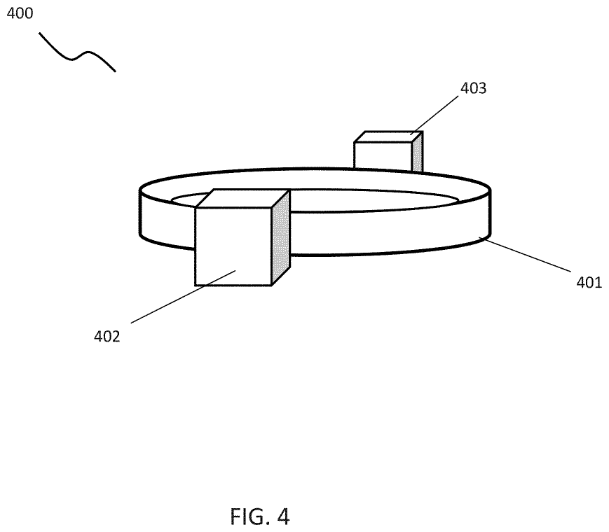

With respect to FIG. 4, a tracking device 400 may be configured to function as a pet collar 401 in accordance with an embodiment. The collar 401 may be fabricated out of any material such as leather, nylon, vinyl, cotton, polyester, hemp, metal, or any combination thereof. In some embodiments, the electrical components of the collar may be distributed into multiple units 402/403 in order to distribute weight on the collar and allow for a better fit on smaller pets. In some embodiments, a first unit 402 may contain the UWB receiver and logic for calculating the location. In some embodiments, a first unit 403 may additionally comprise components that allow for corrective stimulus to be applied or an alarm system to sound. For example, an audio device or an audio circuit may play a tone or series of tones to inform the pet of incorrect behavior or to warn the pet that continued incorrect behavior may result in an alternative corrective measure being employed (e.g., electrical shock, calling the authorities, or the like). In some embodiments, a light (e.g., LED) may flash or illuminate to indicate incorrect behavior. Additionally or alternatively, a vibration may be provided via a vibration mechanism (not pictured). In some embodiments, any combination of one or more of the foregoing may be employed. For example, an audio device may play a tone, a light may illuminate and an electrical shock may be provided.

In some embodiments, the tracking device 400 may provide auditory, visual, and/or haptic stimuli as an early or gentle corrective tool when used as a pet tool. However, if a more direct corrective measure is required, some embodiments may issue an electrical shock (e.g., to the pet via two or more electrodes) or trigger an alarm or messaging system. In some embodiments, the shocking/alarm circuit may be configured to provide a stimulus at a plurality of levels of intensity, and thus may require a complex circuit to manage. For example, various regulators, as shown, may be implemented to enable the tracking device 400 to issue the corrective action (e.g., electrical shock) at one or more intensity levels.

In some embodiments, the multiple units 402/403 may each have batteries and communicate wirelessly, such as through Bluetooth Low Energy . In some embodiments, each unit 402/403 may have a separate charging port used to charge the corresponding battery. In some embodiments, each unit 402/403 may include a status indicator light. The status indicator light for a particular unit may provide information to a user regarding one or more of battery status, communication status, or a recent corrective action. In some embodiments, one or more conductive elements may be used to connect the first unit 402 and the second unit 403. In some embodiments, the one or more conductive elements may be positioned in the collar 401 to provide data and/or power between the units 402/403.

In some embodiments, the collar 401 may be customizable in size and/or style, including material, form factor, pattern, color, or ornamentation. The resulting collar may be configured with a circumference as small as approximately ten inches and thus fit smaller pets.

In some embodiments, the tracking device 400 may further comprise a compass, one or more accelerometers, and/or other sensors. In some embodiments, the second unit 403 may further comprise a GPS or other separate tracking system for tracking the device outside of the system 100. In some embodiments, the components of the second unit 403 may only be activated when the tracking device 400 is not trackable by the system 100 due to range. In alternative embodiments, the second unit 403 may comprise one or more additional wireless communication devices, such as a Long Term Evolution (LTE) antenna.

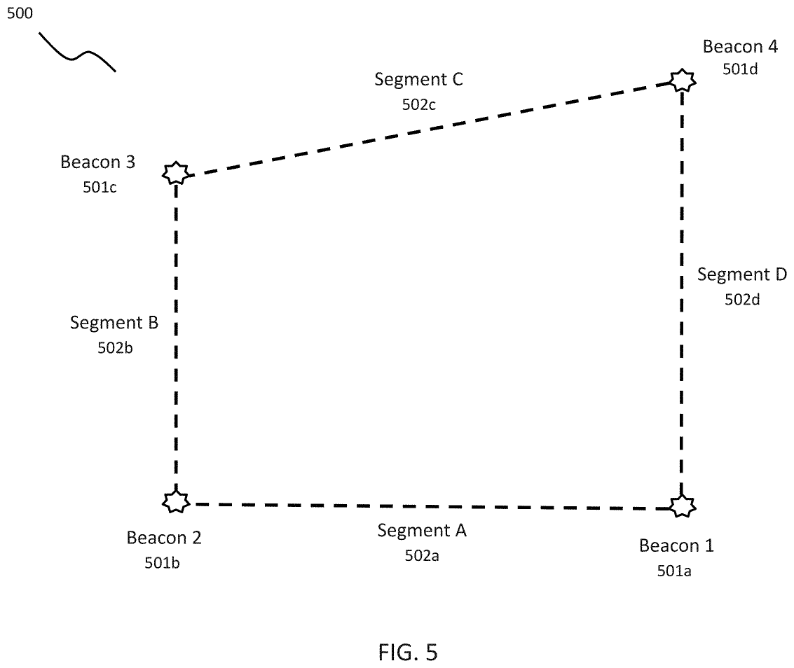

FIG. 5 depicts an overhead view of an example boundary 500 defined by the virtual containment zone system in accordance with an embodiment. The boundary 500 comprises vertices at beacons one 501a, two 501b, three 501c, and four 501d. In some embodiments, the boundary 500 comprises user-specified segments between beacons 501a-d. In some embodiments, the boundary 500 is determined by detecting the closest neighboring beacons. In the illustrative example shown in FIG. 5, the boundary 500 is formed of segments A 502a, B 502b, C 502c, and D 502d. In configuring the boundary 500, each individual segment can be enabled or disabled in regards to tracking and/or performing a corrective action when the tracking device approaches and/or crosses the segment. For example segment D 502d may run along a physical barrier, such as a wall, and may not require any corrective action.

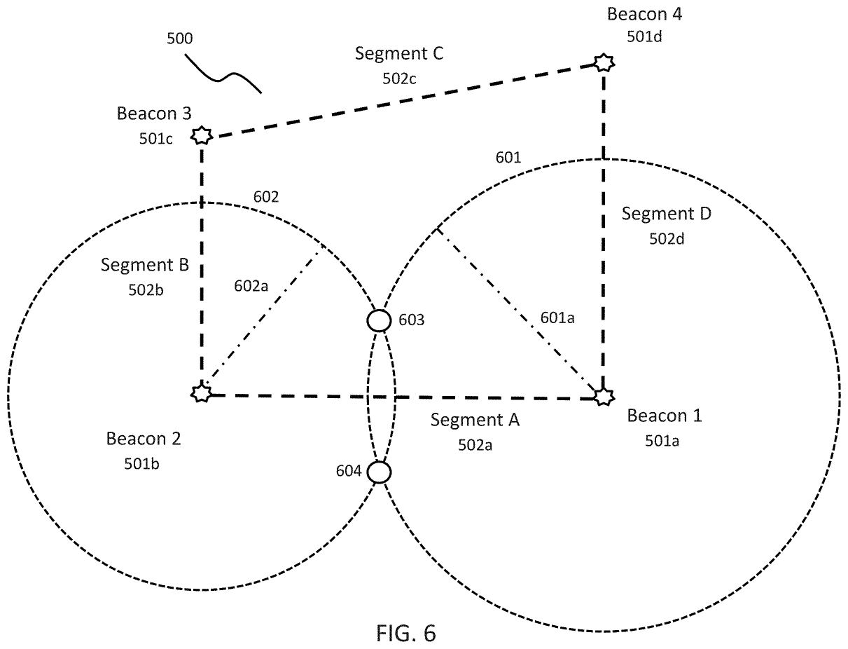

FIG. 6 depicts an illustrative example of the virtual containment zone system functioning in accordance with an embodiment. In the illustrative example, a tracking device receives communication from beacons one 501a and two 502b. The received UWB signals are processed, thereby allowing the tracking element of the tracking device to determine a current distance from beacon one 601a and a current distance from beacon two 602a. As a result of this determination, the tracking device must be on both of the circles 601/602 centered on beacon one 501a and beacon two 501b, respectively, and defined by radii corresponding to those distances 601a/602a. Note that at this point the system is able to determine that the tracking device is at one of two mirrored points with a first point 603 on the inside of the boundary 500 with respect to segment A 502a and a second point 604 on the outside of the boundary 500 with respect to segment A 502a.

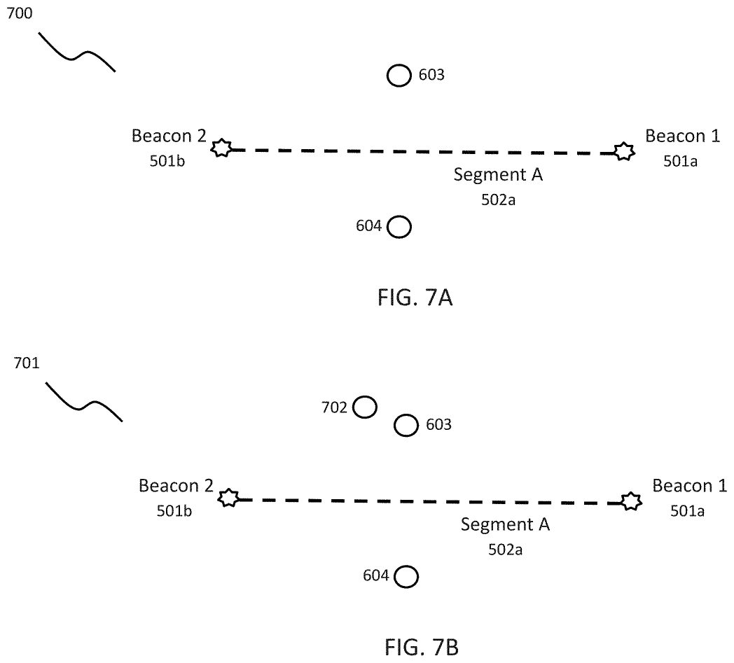

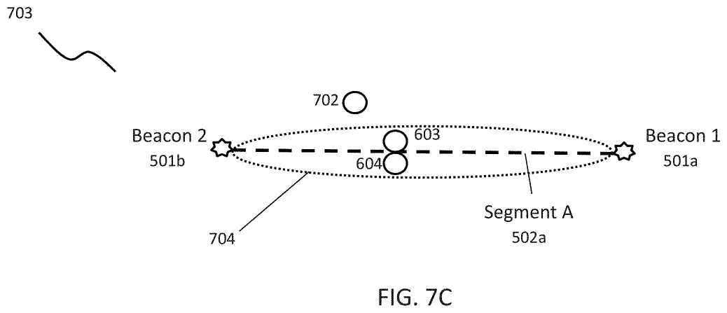

FIGS. 7A-7C provide illustrative examples for a method of determining which of the two mirrored points 603/604 identifies the location of the tracking device in accordance with an embodiment. FIG. 7A depicts the system 700 during an initial configuration, when no additional information is known. In some embodiments the user may provide some initial information or place the tracking device in a particular location to initialize the system 700. For example, the user may notify the system that the tracking device is at the location within the boundary 603. The system 700 may then collect information from sensors on the tracking device, such as from a compass or an accelerometer from which to extrapolate future positions. In some embodiments, each of the beacons may be located relative to magnetic North based on input from the compass.

FIG. 7B depicts a post-initialization state 701 of the system. In this state, one or more known positions 702 are available to assist in determining the proper location of the tracking device. In some embodiments, the one or more known positions 702 are recent prior positions of the tracking device. In some embodiments, the one or more known positions 702 may be determined shortly after the unknown mirrored positions 603/604. In further embodiments, any recent known positions 702 determined before or after the unknown mirrored positions 603/604 are used. Based on input from an accelerometer, the system may determine a speed at which the tracking device has moved. As such, the system may estimate which of the mirrored positions 603/604 is correct based on the recent known location 702. In some embodiments, the compass data may additionally or alternately be used to determine a trajectory of the tracking device from the recent known location 702.

As shown in FIG. 7C, a scenario 703 is presented in which the tracking collar is proximate to the boundary 502a. In such a scenario 703, the resulting mirrored points 603/604 may be sufficiently close to each other that the system cannot identify which of the mirrored points 603/604 represents the present location of the tracking device based on a recent known location 702. This uncertainty region 704 around the boundary 501a may be considered when configuring any corrective actions.

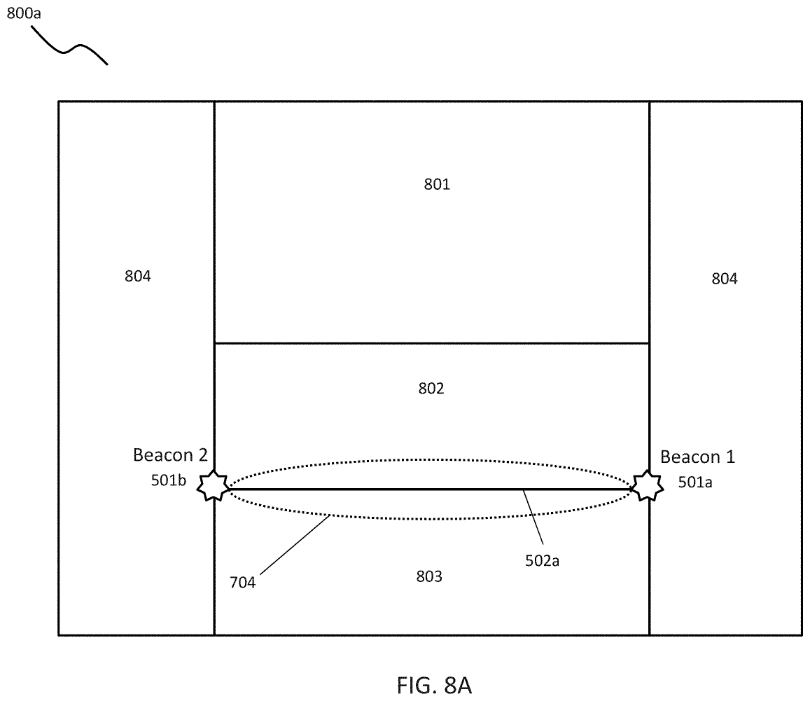

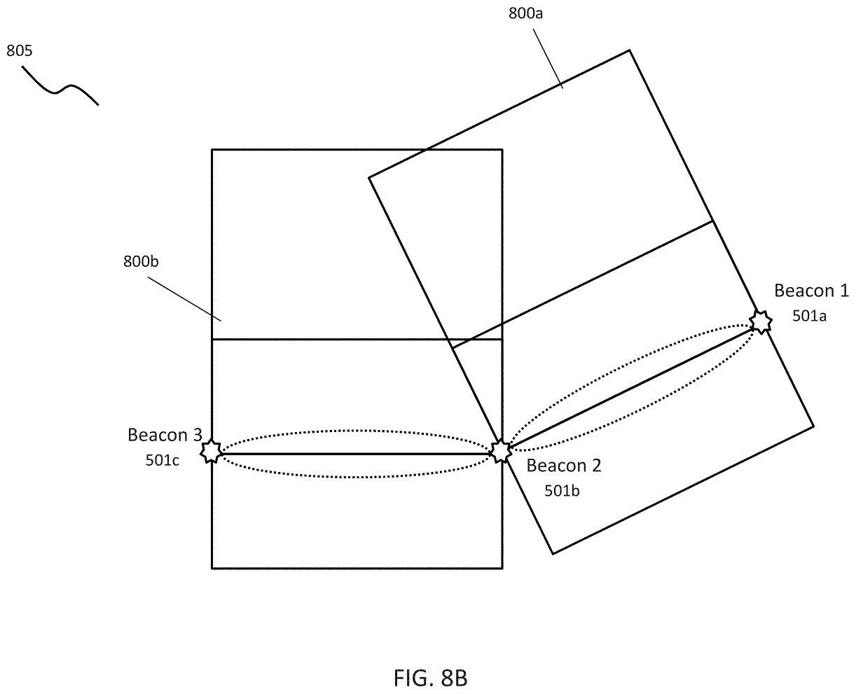

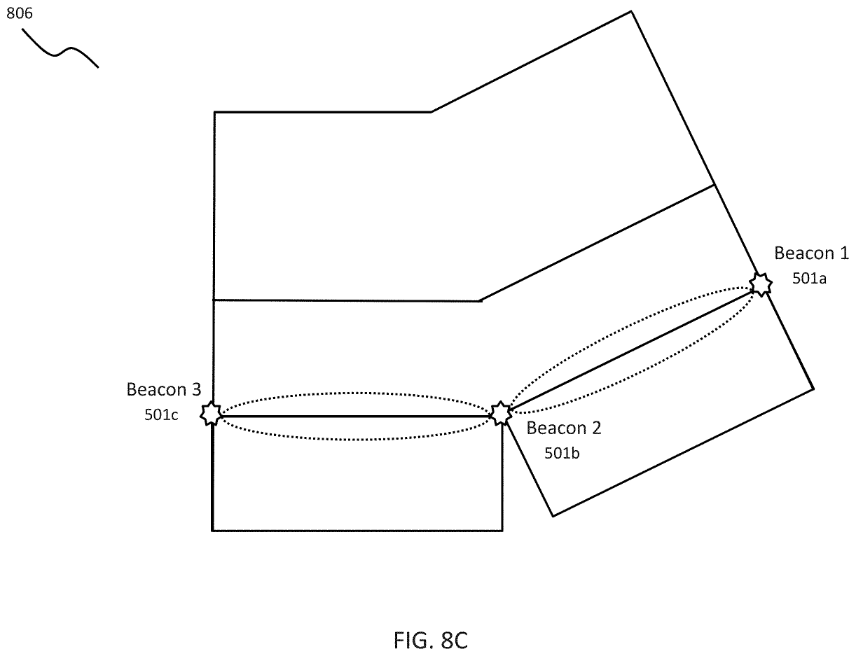

Referring to FIG. 8A, an illustrative example of a series of segment zones 800a surrounding a boundary segment 502a is depicted in accordance with an embodiment. Each segment zone may cause a different response in the tracking device. The segment zones may comprise a first zone 801, an area inside the boundary where the tracking device may move freely, a buffer zone, a second zone 802 proximate to the boundary segment 502a where a low level corrective action such as an audio or visual warning is issued, an uncertainty zone 704 where higher level corrective action such as an electric shock is issued, and a third zone 803 outside of the boundary area where the system may provide a notification to a user. In an embodiment, the notification initiated by detection of the pet in the third zone 803 may include the activation of at least one of an LTE or GPS device. In an alternative embodiment, the notification that the tracking device has entered the outside zone 803 may be sent to the user via one or more of Bluetooth® and/or WIFI. Lateral zones 804 define an area where this segment 502a has no effect in corrective action.

FIG. 8B depicts an illustrative example 805 of two overlapping sets 800a, 800b of segment zones. In some embodiments, a priority system may determine whether to apply the first set 800a or second set 800b of segment zones. An illustrative mapping 806 joining the two overlapping segment zones is depicted in FIG. 8C in accordance with an embodiment. In the embodiment of FIG. 8C, the segment zones inside the boundary are prioritized based on their proximity to the boundary. More particularly, the uncertainty zones of the two overlapping sets 800a, 800b of segment zones may be given the highest priority, the second zones of the two overlapping sets 800a, 800b of segment zones may be given the next highest priority, and the first zones of the two overlapping sets 800a, 800b of segment zones may be given the lowest priority in determining which zone applies to a given location. As such, when mapping the overlap, the highest priority of either segmented zone in the overlap is used.

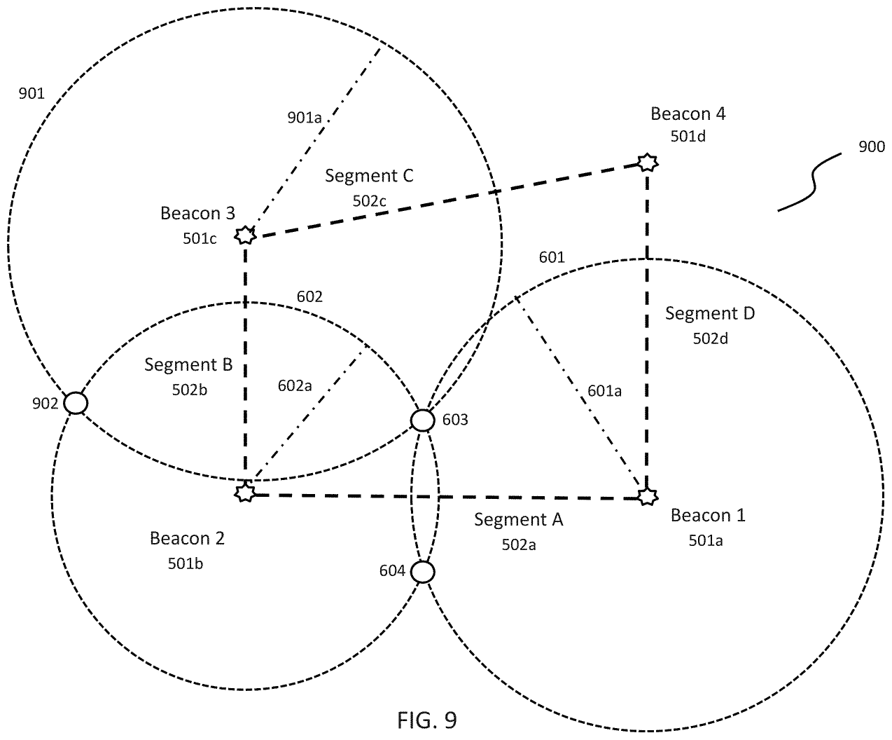

As shown herein, the virtual containment system can fully function with only two beacons in range of the tracking device. FIG. 9 depicts an illustrative example where the tracking device is in range of three beacons. In the illustrative example, the tracking device receives communication from beacon one 501a, beacon two 502b, and beacon three 501c. The received UWB signals are processed, thereby allowing the tracking element of the tracking device to determine a current distance from beacon one 601a, a current distance from beacon two 602a, and a current distance from beacon three 901a. As a result of this determination, the tracking device must be on the circles 601/602/901 centered on the corresponding beacons 501a-c, respectively, and defined by radii corresponding to those distances 601a/602a/901a. In some embodiments, the system may determine the single point at which all three circles intersect and identify that as the location 603 of the tracking device. In other embodiments, the system may calculate the two mirrored points for each of segment A 502a and segment B 502b and determine which of the points is closest to the other segment. An average between the closest points may be determined as the location of the tracking device.

In instances where more than three beacons are within range, the segments defined by the beacons may also be averaged into the result to further increase accuracy and/or reliability. In some embodiments, using more than two beacons may enable the system to identify the location of the tracking device with less processing.

In some embodiments, as described above, the calculations are performed on the tracking element of the tracking device. However, the subject matter disclosed herein is not so limited. The calculations may be performed on a processing device external to the tracking device, including, for example, a mobile phone application.

Additionally, some embodiments may allow the tracking device and/or beacons to communicate with one or more smart devices/objects (e.g., the Internet of Things). Some non-limiting examples of smart devices/objects may include a dog door with a locking mechanism that can be activated or deactivated based on the location of the tracking device and a feeding system that may be activated based on the location of the tracking device. It should be understood that any implementation of a smart object relative to the tracking device's location may be implemented in accordance with the various embodiments discussed herein.

Computer-readable program instructions for carrying out operations described herein may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including local area network (LAN) or wide area network (WAN), or the connection may be made to an external computer (for example, through the Internet using an Internet Service Provider).

These computer-readable program instructions may be provided to a processor of a computer or other programmable data processing apparatus to produce a machine, such that the instructions, which execute via the processor of the computer or other programmable data processing apparatus, implement the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operations to be performed on the computer, other programmable apparatus, or other device to produce a computer-implemented process, such that the instructions which execute on the computer, other programmable apparatus, or other device implement the functions/acts specified in the flowchart and/or block diagram block or blocks.

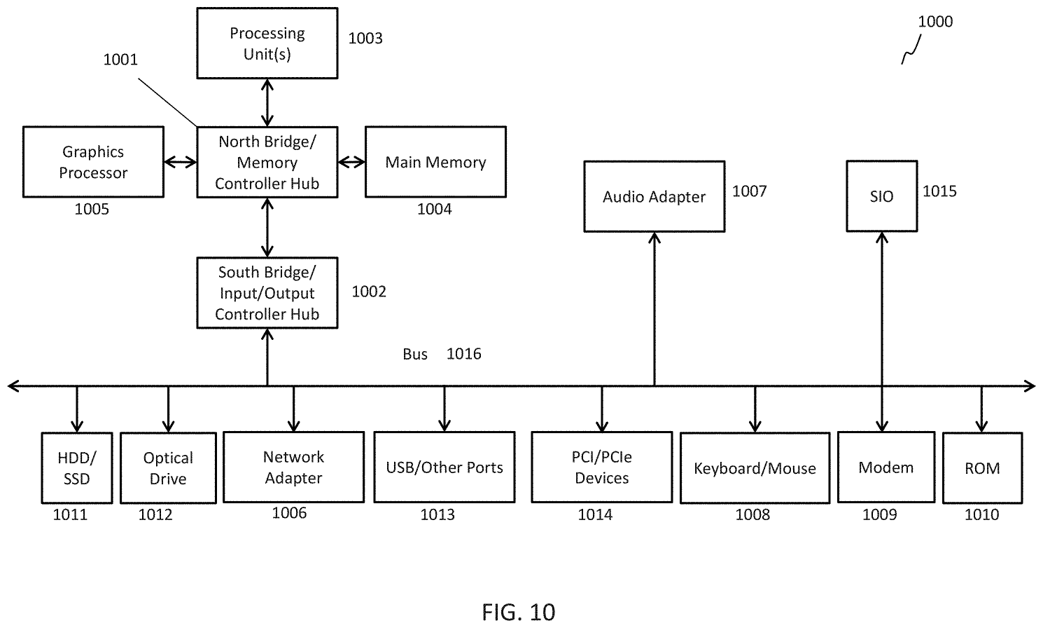

FIG. 10 is a block diagram of an example data processing system 1000 in which aspects of the illustrative embodiments are implemented. Data processing system 1000 is an example of a computer, such as a server or client, in which computer usable code or instructions implementing the process for illustrative embodiments of the present invention are located. In some embodiments, FIG. 10 may represent a server computing device.

In the depicted example, data processing system 1000 can employ a hub architecture including a north bridge and memory controller hub (NB/MCH) 1001 and south bridge and input/output (I/O) controller hub (SB/ICH) 1002. Processing unit 1003, main memory 1004, and graphics processor 1005 can be connected to the NB/MCH 1001. Graphics processor 1005 can be connected to the NB/MCH 1001 through, for example, an accelerated graphics port (AGP) or PCl/PCIe port.

In the depicted example, a network adapter 1006 connects to the SB/ICH 1002. An audio adapter 1007, keyboard and mouse adapter 1008, modem 1009, read only memory (ROM) 1010, hard disk or solid state drive (HDD/SSD) 1011, optical drive (e.g., CD or DVD) 1012, universal serial bus (USB) ports and other communication ports 1013, and PCl/PCIe devices 1014 may connect to the SB/ICH 1002 through bus system 1016. PCl/PCIe devices 1014 may include Ethernet adapters, add-in cards, and PC cards for notebook computers. ROM 1010 may be, for example, a flash basic input/output system (BIOS). The HDD/SSD 1011 and optical drive 1012 can use an integrated drive electronics (IDE), serial advanced technology attachment (SATA), or M.2 interface. A super I/O (SIO) device 1015 can be connected to the SB/ICH 1002.

An operating system can run on processing unit 1003. The operating system can coordinate and provide control of various components within the data processing system 1000. As a client, the operating system can be a commercially available operating system. An object-oriented programming system, such as the JavaTM programming system, may run in conjunction with the operating system and provide calls to the operating system from the object-oriented programs or applications executing on the data processing system 800. As a server, the data processing system 1000 can be an IBM® eServer™ System p® running the Advanced Interactive Executive operating system or the Linux operating system. The data processing system 1000 can be a symmetric multiprocessor (SMP) system that can include a plurality of processors in the processing unit 1003. Alternatively, a single processor system may be employed.

Instructions for the operating system, the object-oriented programming system, and applications or programs are located on storage devices, such as the HDD/SSD 1011, and are loaded into the main memory 1004 for execution by the processing unit 1003. The processes for embodiments described herein can be performed by the processing unit 1003 using computer usable program code, which can be located in a memory such as, for example, main memory 1004, ROM 1010, or in one or more peripheral devices.

A bus system 1016 can be comprised of one or more busses. The bus system 1016 can be implemented using any type of communication fabric or architecture that can provide for a transfer of data between different components or devices attached to the fabric or architecture. A communication unit such as the modem 1009 or the network adapter 1006 can include one or more devices that can be used to transmit and receive data.

Those of ordinary skill in the art will appreciate that the hardware depicted in FIG. 10 may vary depending on the implementation. Other internal hardware or peripheral devices, such as flash memory, equivalent non-volatile memory, or optical disk drives may be used in addition to or in place of the hardware depicted. Moreover, the data processing system 1000 can take the form of any of a number of different data processing systems, including but not limited to, client computing devices, server computing devices, tablet computers, laptop computers, telephone or other communication devices, personal digital assistants, and the like. Essentially, data processing system 1000 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112(f) unless the element is expressly recited using the phrase “means for.”

Although the disclosure has been described with reference to exemplary embodiments, it is not limited thereto. Those skilled in the art will appreciate that numerous changes and modifications may be made to the embodiments described herein and that such changes and modifications may be made without departing from the true spirit of the disclosure. It is therefore intended that the appended claims be construed to cover all such equivalent variations as fall within the true spirit and scope of the disclosure.

1. A virtual containment zone system comprising:
a plurality of beacons, wherein each of the plurality of beacons define a vertex of a virtual containment zone boundary forming a perimeter of a virtual containment zone, wherein each of the plurality of beacons employ ultra-wideband;
a plurality of joining segments, wherein each of the plurality of joining segments define the virtual containment zone boundary between two of the plurality of beacons; and
a tracking device comprising a processing device, wherein the processing device configured to:
determine the virtual containment zone boundary,
enable one or more of the plurality of joining segments to take an action in response to a location of the tracking device,
determine the location of the tracking device,
determine, based on the location of the tracking device, an action to take, and
send, to the tracking device, a signal to perform the action.

2. The system of claim 1, wherein the tracking device is configured to function as a pet collar and the action to perform is to generate a corrective action to the tracking device.

3. The system of claim 2, wherein the corrective action comprises one or more of an electric shock, a vibration, and a played tone.

4. The system of claim 1, wherein the tracking device comprises:
a pet collar;
a first unit comprises a receiver and components configured to provide a corrective stimulus, wherein the first unit attached to a first position on the pet collar;
a second unit attached to a second position on the pet collar, wherein the second unit is connected to the first unit by a conductive element, wherein the first position and the second position are separated on the pet collar by a distance; and
electrical components configured to wirelessly communicate with an external processing device, wherein the electrical components are distributed between a first unit and a second unit such that a weight on the pet collar is distributed.

5. The system of claim 4, wherein the second unit comprises a separate tracking system for tracking the tracking device outside of the virtual containment zone boundary and wherein the action is to perform is to activate the separate tracking system when the location of the tracking device is determined to be outside of the virtual containment zone.

6. The system of claim 1, further comprising:
an external processing device configured to wirelessly communicate with the tracking device,
wherein the tracking device is further configured to wirelessly communicate with the external processing device, and
wherein the method performed by the tracking device further comprises transmitting, to the external processing device, the location of the tracking device.

7. The system of claim 1, wherein the virtual containment zone comprises a plurality of segment zones, wherein a segment zone is an area within virtual containment zone, wherein the processing device is further configured to:
receive, for each of the plurality of segment zones, corrective actions to perform in response to determining that location of the tracking device is within each of the plurality of segment zones, wherein a first corrective action for a first segment zone is a higher severity than a second corrective action for a second segment zone; and
determine which of the plurality of segment zones comprises the location of the tracking device,
wherein determining the action to take is further based on the determined segment zone.

8. A computer implemented method in a data processing system comprising a processor and a memory comprising instructions, which are executed by the processor to cause the processor to implement the method for tracking an asset in a virtual containment zone comprising a plurality of beacons, wherein each of the plurality of beacons employ ultra-wideband, the method comprising:
receiving, from an external processing device,
determining a boundary of a virtual containment zone, wherein the boundary comprises a plurality of joining segments forming a continuous shape;
enabling each of the plurality of joining segments to take an action in response to a location of a tracking device attached to the asset;
receiving, from each of two of the plurality of beacons, a communication;
determining, based on the received communications, the location of the tracking device;
determining, based on the location of the tracking device and the plurality of enabled joining segments, an action to perform; and
sending, to the tracking device, a signal to perform the action.

9. The method of claim 8, wherein determining the boundary of the virtual containment zone comprises:
receiving, for each of a plurality of beacons, a closest neighboring beacon, wherein a joining segment exists between each of the plurality of beacons and the closest neighboring beacon for each of the plurality of beacons.

10. The method of claim 8, further comprising:
receiving, from the external processing device, an instruction to disable one of the plurality of joining segments such that the tracking device can leave the virtual containment zone without receiving the action; and
disabling the one of the plurality of joining segments.

11. The method of claim 8, wherein the action to perform is to generate a corrective action to the tracking device.

12. The method of claim 8, wherein the action is to perform no action.

13. The method of claim 8, wherein the action to perform is communicating with a smart device to activate the smart device.

14. The method of claim 8, further comprising:
determining that the location of the tracking device is outside of the virtual containment zone,
wherein the action to perform is to active a GPS tracking feature of the tracking device.

15. The method of claim 8, wherein the virtual containment zone comprises a plurality of segment zones, wherein a segment zone is an area within the virtual containment zone, the method further comprising:
receiving, for each of the plurality of segment zones, actions to perform in response to determining that location of the tracking device is within each of the plurality of segment zones; and
determining which of the plurality of segment zones comprises the location of the tracking device,
wherein determining the action to take is further based on the determined segment zone.

16. The method of claim 8, further comprising:
determining a combined segment zone's boundary when a first segment zone of a first virtual containment zone overlaps with a second segment zone of a second virtual containment zone by:
determining that the first segment zone overlaps with the second segment zone,
determining a first distance between the first segment zone and a first boundary of the first virtual containment zone,
determining a second distance between the second segment zone and a second boundary of the second virtual containment zone, and
determining the combined segment zone's boundary by prioritizing the first segment zone's boundary over the second segment zone's boundary.

17. The method of claim 8, wherein determining the location of the tracking device comprises:
receiving a first communication from a first beacon and a second communication from a second beacon;
determining, based on the first communication, a first distance from a tracking device to the first beacon;
determining, based on the second communication, a second distance from a tracking device to the second beacon;
determining, based on the first distance and the second distance, a first potential location of the tracking device and a second potential location of the tracking device;
determining that the first potential location is within the virtual containment zone; and
determining the location of the tracking device is the first potential location.

18. The method of claim 17, wherein determining that the first potential location is within the virtual containment zone at a first time is based on prior position of the tracking device at a previous time.

19. The method of claim 17, wherein determining that the first potential location is within the virtual containment zone at a first time is based on prior position of the tracking device at a subsequent time.

20. The method of claim 8, wherein determining the location of the tracking device comprises:
receiving a first communication from a first beacon, a second communication from a second beacon, and a third communication from a third beacon;
determining, based on the first communication, a first distance from a tracking device to the first beacon;
determining, based on the second communication, a second distance from a tracking device to the second beacon;
determining, based on the third communication, a third distance from a tracking device to the third beacon; and
determining, based on the first distance, the second distance, and the third distance, the location of the tracking device.
